(19) United States
(12) Patent Application Publication
(10) Pub. No.: US 2012/0271945 A1
(43) Pub. Date: Oct. 25, 2012

(54) Obtaining Server Address when Domain Name System Proxy Solution Fails

(75) Inventors: Jianhui Xie, Redmond, WA (US); Leszek Mazur, Kirkland, WA (US); Sean Daniel, Victoria (CA); Ferry Susanto, Bellevue, WA (US)

(73) Assignee: MICROSOFT CORPORATION, Redmond, WA (US)

(21) Appl. No.: 13/090,655

(22) Filed: Apr. 20, 2011

(51) Int. Cl. G06F 15/16; G06F 15/173

(52) U.S. Cl. 709/225; 709/227

(57) ABSTRACT

The subject disclosure is directed towards establishing communication between a client computer and a network resource on a computer network when DNS resolution has failed because of a DNS proxy solution. A user may request that the client use a tool as an alternative to DNS resolution. The client may monitor the network for a broadcast from the network resource, which contains information needed for the client to access the network resource. The network resource may broadcast the information from time to time, or it may broadcast it in response to a specific request from the client.

### BACKGROUND

The Domain Name System (or DNS) refers to a hierarchical naming system for objects connected to a computer network and for translating human-friendly names into Internet Protocol (IP) addresses. The DNS is used to identify computers, resources and services connected to the network. The DNS is used to identify objects on the internet, such as domain names, as well as on local networks, such as server computers or printers. When a user requests to connect to an object on the network using the human-friendly name, the system can use the DNS to obtain the corresponding IP address and connect to the object.

The DNS provides effective translation of the human-friendly name of network objects, provided the name is typed correctly, and provided the DNS is current. However, situations arise in which resolution of the DNS name fails. For example, when a new client computer is added to a network, or when restoration of a client computer occurs, the client computer needs to obtain the record of the IP address of the server computer on the network. Similarly, when a new server is added or a restoration of a server computer occurs, the client may not be able to locate it using the DNS.

On networks that do not have a local DNS server, server names may be resolved by a DNS proxy solution. When given a local server name, the DNS proxy solution may respond that it does not know how to resolve the server name, whereby the client uses NetBIOS to locate the server address. However, instead of responding when it cannot resolve the name, the DNS proxy solution may be configured to redirect the computer to an alternate IP address (e.g., of a website). In this situation, NetBIOS is not invoked, and the server IP address is not able to be located.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which access to a resource (e.g., server) may be gained by a computer on a computer network even though the default name resolution protocol has failed. In one aspect, when a computer cannot locate a specific resource on the computer network, a user or process may activate a tool. The tool may broadcast a message over the computer network requesting that the resource respond with a message identifying the resource over the network.

Upon receiving the broadcast message, the resource may respond with a message that satisfies the request. The message may include the name of the resource and the IP address of the resource. The computer may then receive the resource's message and obtain the information needed to communicate via unicast (e.g., directly) with the resource over the computer network. The computer may then store this information for future use.

In the event that the resource does not relatively promptly respond with a message that satisfies the request within a monitored period of time, the computer may rebroadcast the request for the resource to provide the identifying information. The computer may repeat this cycle of broadcasting the request and monitoring the network for a broadcast that satisfies the request. The computer may, after some number of cycles, change the period of time between rebroadcasts of its request.

In one aspect, a resource on a computer network may occasionally (which may be periodic) broadcast identifying information about the resource over the computer network. The identifying information may include the name and IP address of the resource. A computer on the network, (e.g., one that that has invoked the tool to find the resource) may be monitoring the network for the broadcast message and may obtain the identifying information. The computer may then use the identifying information to communicate directly with the resource over the network. The computer may also store the identifying information.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing exemplary non-limiting networked components including mechanisms for locating the addresses of one or more network resources (e.g., a server).

FIG. 2 is a flow diagram representing example steps for determining the IP address of a server on a computer network.

FIG. 3 is a flow diagram representing example steps for determining the IP address of a server on a computer network, as initiated by a client.

FIG. 4 is a flow diagram representing example steps for determining the IP address of a server on a computer network, including retry logic.

FIG. 5 is a flow diagram representing example steps for determining the IP address of a server on a computer network, when not initiated by a client.

FIG. 6 is a block diagram representing exemplary non-limiting networked environments in which various embodiments described herein can be implemented.

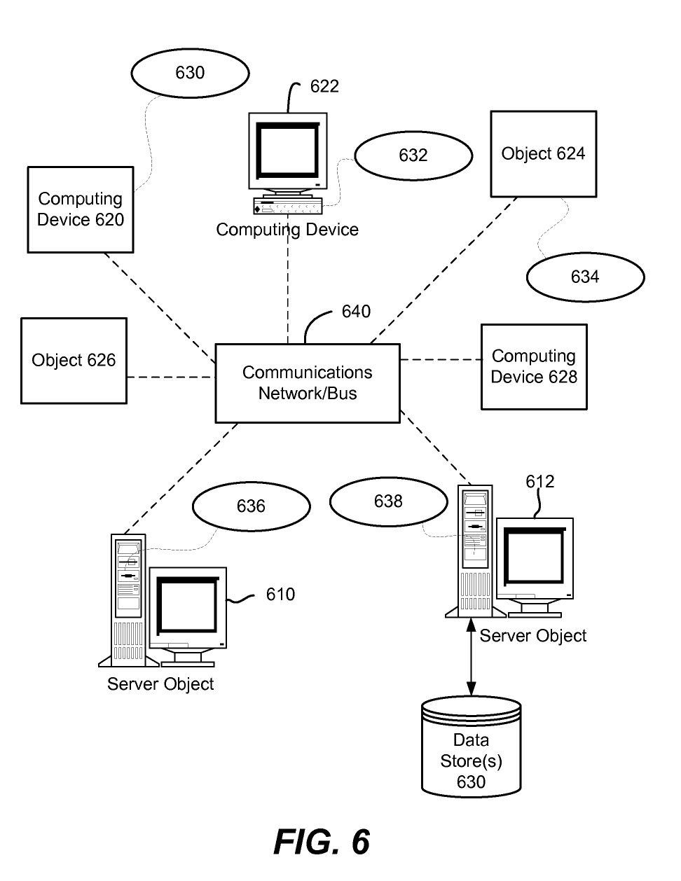

FIG. 7 is a block diagram representing an exemplary non-limiting computing system or operating environment in which one or more aspects of various embodiments described herein can be implemented.

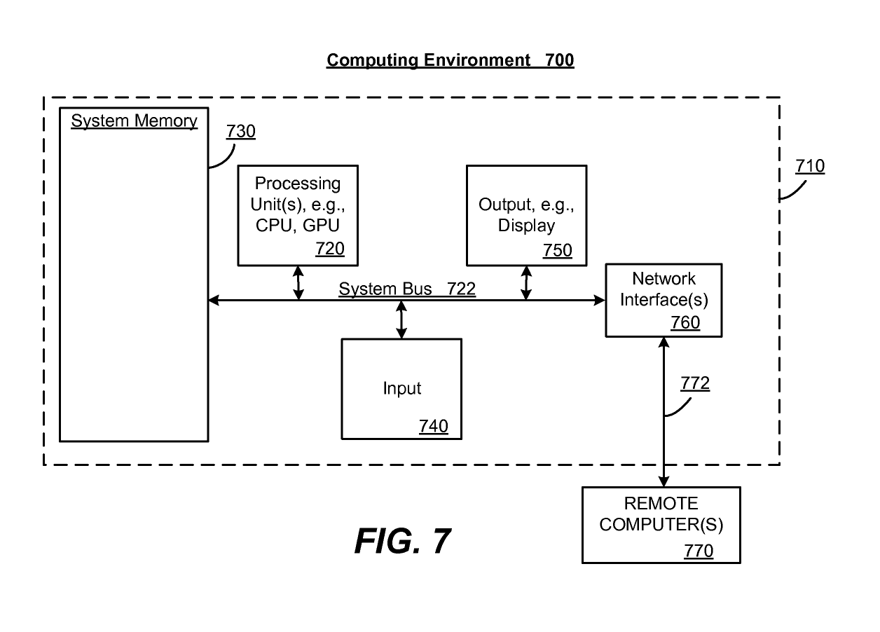

### DETAILED DESCRIPTION

Various aspects of the technology described herein are generally directed towards locating a resource such as a server on a computer network when the Domain Name System (DNS) resolution of that resource has failed to work as expected. In one aspect, resources are each associated with maintained data that contains information about each resource. The maintained data includes the name of the resource and the Internet Protocol (IP) address of the resource. As will be understood, the maintained data provides for location and usage of the resource.

It should be understood that any of the examples herein are non-limiting. For one, while client computers and servers are used as examples of resources, other types of resources (e.g. network printers, and other network resources) may benefit from the technology described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and networking in general.

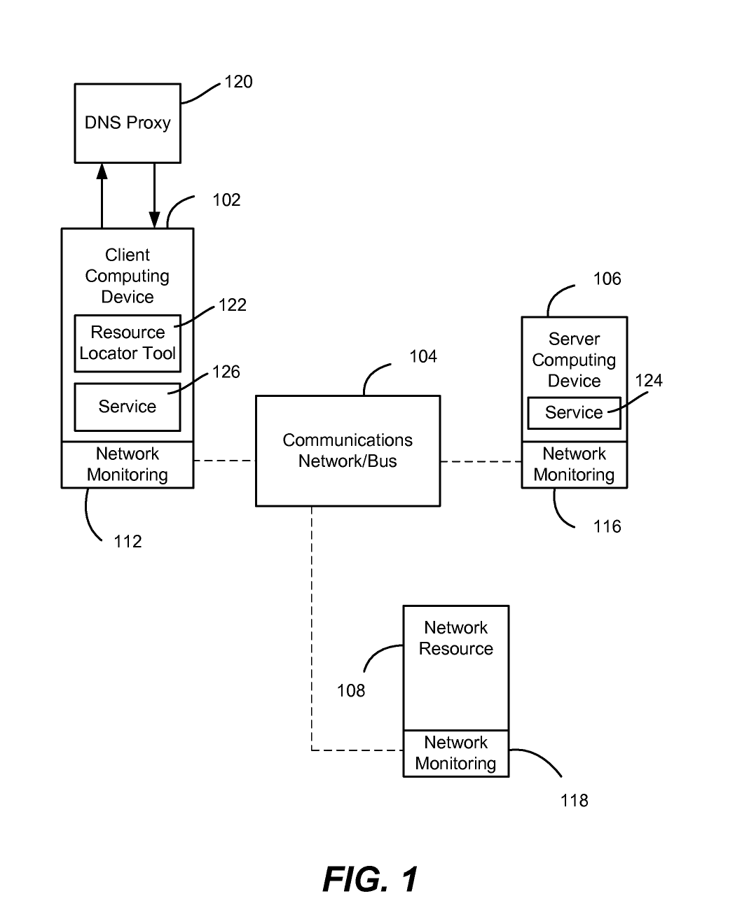

FIG. 1 shows a block diagram of an exemplary networked or distributed computing environment. The distributed computing environment comprises a client computing device 102 communicatively connected to a server computing device 106 and other network resources 108 (e.g. network printer) via communications network 104. The client computing device 102 includes a monitoring object 112 which includes a monitoring function for monitoring communications traffic on the communications network. The server computing device 106 includes a monitoring object 116 for monitoring communications traffic on the communications network. The network resource 108 includes a monitoring object 118 for monitoring communications traffic on the network. The monitoring objects 112, 116, and 118 may be configured to receive broadcast messages on the communications network even though such messages may not specify a particular destination device.

As described herein, for various reasons the client computing device 102 may need to determine the IP address of the server computing device 106 or the network resource 108. In general, when attempting to locate a server, for example, the client computing device 102 makes a DNS request, which may be handled by a DNS proxy 120. However, the DNS proxy 120 may not provide the correct IP address, e.g., it may be configured to provide an address of an Internet website that pays revenue when advertisements are accessed,

When this occurs, a user or process at the client computing device 102 may launch a resource locator tool 122 that obtains the IP address (and possibly other data such as version information) from a server service 124, based on the technology described herein. The tool 122 also saves the server name and IP address in a permanent cache, e.g., in the client system's hosts file, whereby it is accessible to client components whenever needed. The tool 122 may be initially downloaded from a help website, provided on a manufacturer's website or setup disk, and so forth. Once in the hosts file cache, a standard operating system service 126 in the client operates to keep the IP address up to date, e.g., as it occasionally changes such as when the server or router reboots.

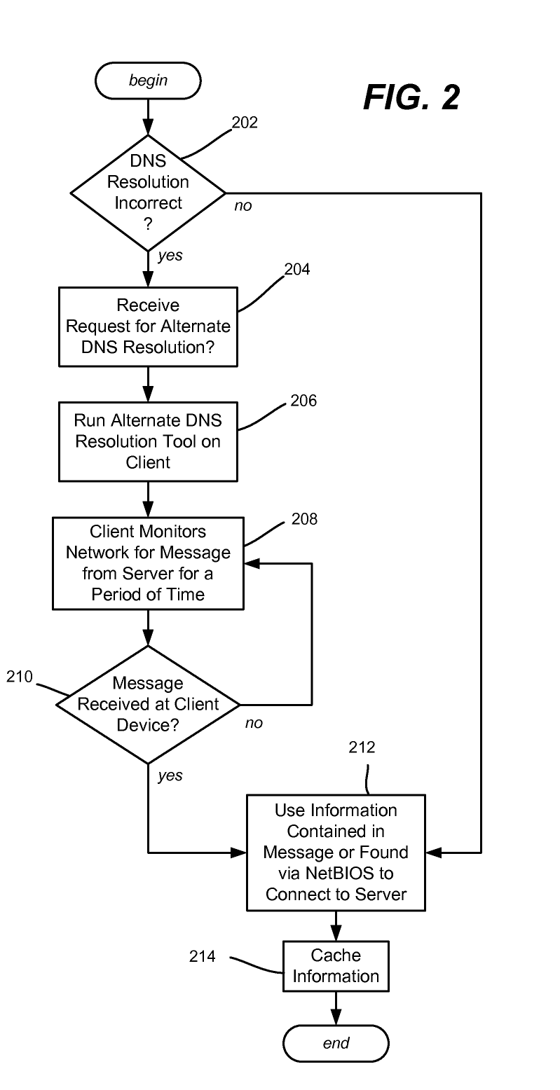

FIG. 2 shows example steps of a flow diagram representing general logic of an alternate DNS resolution process. As represented by step 202, if DNS resolution is incorrect, because the proxy solution returned an incorrect address (e.g., of a website), a request to perform alternate DNS resolution is received (step 204). Note that if the proxy returns information indicating that it cannot resolve the address, this is not incorrect, and NetBIOS is used (not explicitly shown in FIG. 2) to obtain the address.

When incorrect, the alternate DNS resolution tool is run at step 206, after downloading it/installing it an initial time, which broadcasts a message as described below. At the same time, the server service is monitoring the network for broadcast messages from the server is performed at step 208. At step 210 a check is made to determine if a response message has been received at the client from the server. If the message has not been received then the monitoring for a message continues for some number of times/period of time, as also described below.

If a message is received as determined by step 210, then the information in the message can be used to connect to the server; connection is represented via step 212. Note that once the information is obtained, it may be cached for future use as represented by step 214.

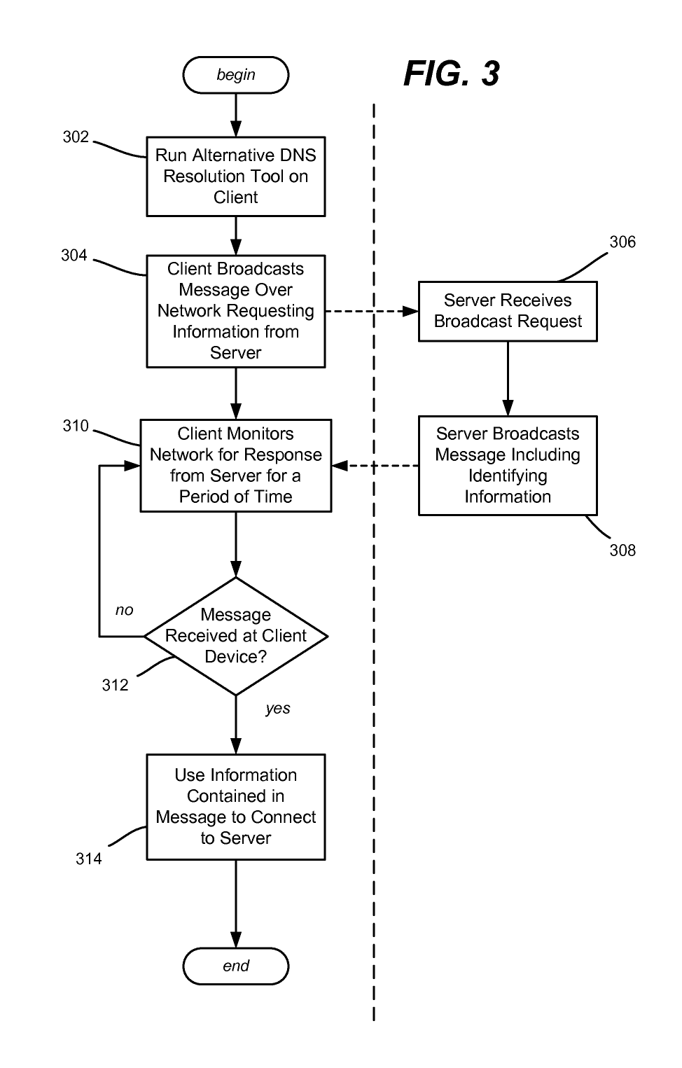

FIG. 3 shows exemplary logic of one implementation of an alternative DNS resolution tool. As conceptually illustrated in FIG. 3, actions on the left side of the dashed vertical line occur on the client, while those on the right side of the line occur at the server.

After receiving a request to run the alternative DNS resolution tool at step 302, the client (via the tool) broadcasts a message over the network at step 304, and monitors the network for a response at step 310. The message broadcast at step 304 may be a User Datagram Protocol (UDP) message. If the resource is properly connected and running a response service, the message broadcast at step 304 is received and handled by the specific resource (e.g. server) about which the client needs the address information.

The server receives the broadcast request at step 306, and in response, broadcasts a reply message including identifying information at step 308. The server broadcast message may include the server name and the server IP address, as well as possibly additional information (e.g. version information).

As represented by step 312, the client determines whether the message has been received. In the event that the message is received, the information contained within the message may be used to connect to the resource at step 314. In the event that more than one message is received, the client computing device may select an appropriate one of the messages to utilize. Alternatively, the client computing device may present, through an interface, a listing of the available servers, services, or other resources that sent messages in response to the broadcast message. The client computing device may then receive an indication of a selection of one or more of the presented servers, services or resources.

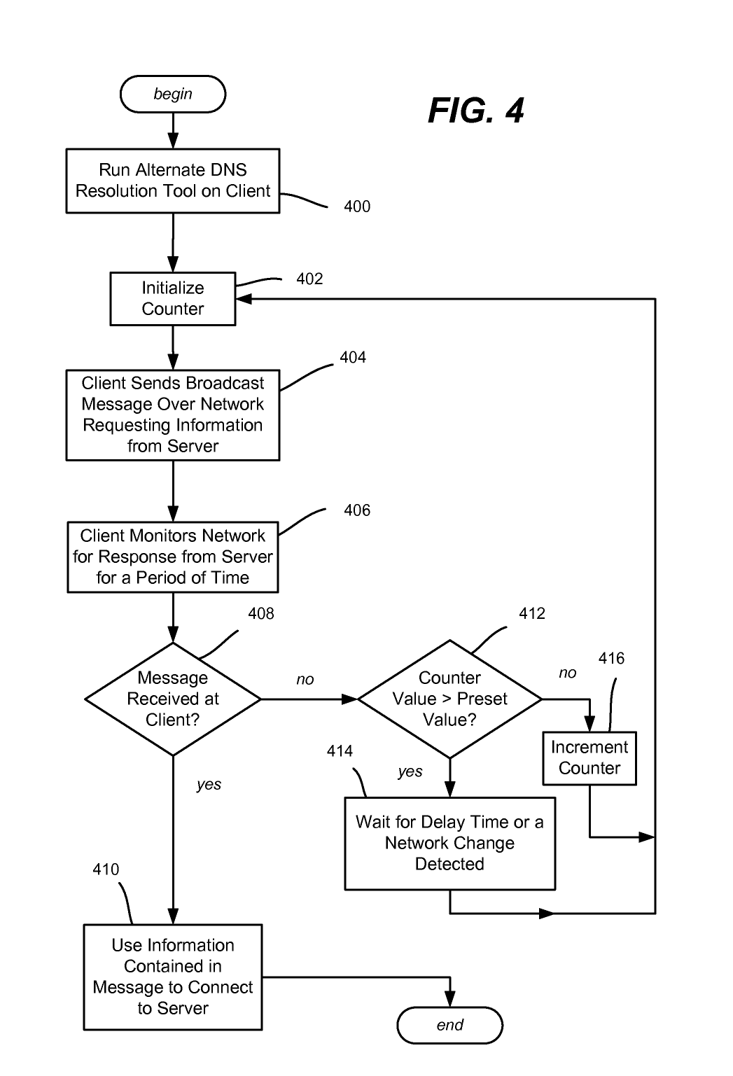

FIG. 4 shows an example logic that may be used by the client (e.g., the tool) while waiting for a message from the server. In one implementation, the client runs the alternate DNS resolution tool at step 400. The client initializes a counter at step 402 and sends a broadcast message over the network requesting information from a server at step 404. The client then monitors the network for response for a period of time at step 406. After the period of time elapses, the client determines whether the message has been received at step 408. If the message has been received, then the information contained in the message can be used to connect to the resource at step 410.

If, the message has not been received at step 408, then the client determines (e.g., using the counter) for how many time periods the client has been monitoring at step 412. If the number at step 412 is below a threshold, (e.g., three) then the client increments the counter at step 416, resends the broadcast message at step 404, and monitors for another time period at step 406. If the number of time periods tracked by the counter as evaluated at 412 reaches the threshold, the client resets the counter and waits at step 416 for some delay time (e.g., for ten minutes) or until a network change is detected. The process is then resumed, until the client determines if the message has been received at block 408. Note that after some number of unsuccessful iterations, the client may decide to end the process and prompt the user, for example.

The exemplary logic shown in FIG. 4 may be applicable in a variety of circumstances. One such circumstance in which aspects of the alternate DNS resolution tool are useful is a bare metal restore of the client. A bare metal restore describes a type of restoration of a computer system without any requirements as to previously installed software. When a client has a bare metal restore performed, all of the IP addresses for the resources on the network are erased, there are no resource name-IP address mappings for the client service 128 to update, and the client cannot find the server to restore its backed-up data.

To avoid this problem, the client may be given restore media such as a restore CD or other mechanism (e.g., USB drive). When the client boots from the restore CD, the tool is automatically invoked, and the server located.

Another such circumstance is what is known as a “bare metal restore” being performed on a server on the network. In particular, if a server on the network has a bare metal restore performed on it, the client is unable to communicate with it. In this situation, a user will press a restore button on the server or the like to begin the restore, and the server will begin broadcasting its address to whatever clients are listening. The user also knows to run the tool or take similar steps on the client, so that the client will act on the broadcast message and connect to the server.

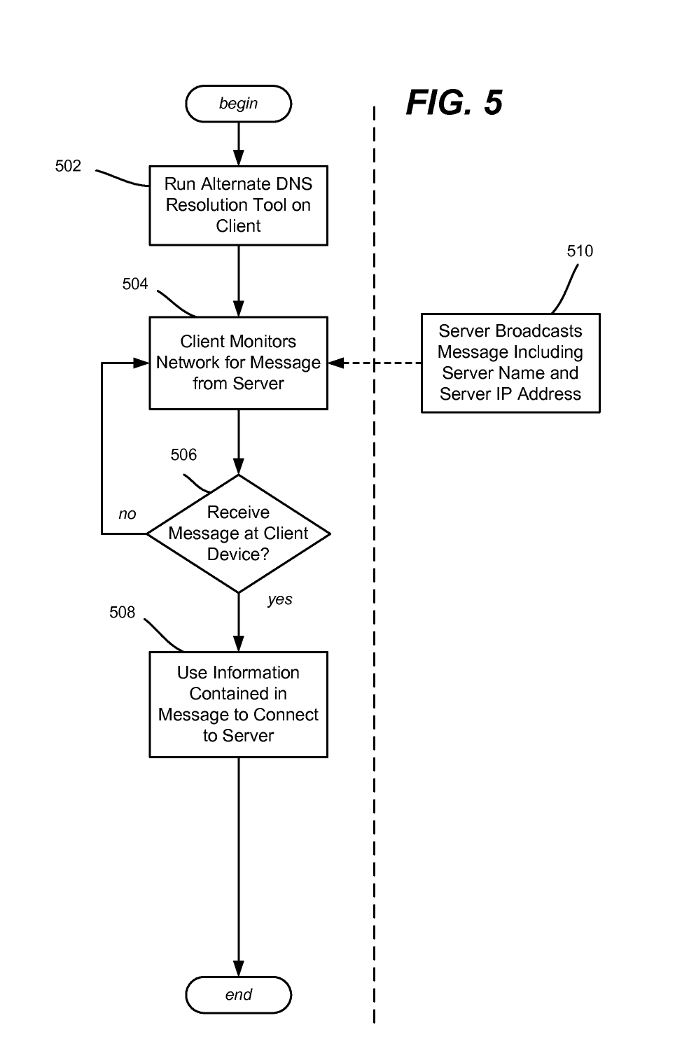

FIG. 5 shows an alternative exemplary logic of another aspect of an alternate DNS resolution tool, which is based upon the server broadcasting its information. This may be used instead of the above-described tool in which the client broadcasts, or in conjunction with the above-described tool when the server broadcasts as part of a bare metal restore and the client enters a broadcast listening mode for the restored server. Note however that except as part of a bare metal restore, it is generally inefficient for a server to regularly broadcast its information, as normally the clients already have it.

The client runs the alternate DNS resolution tool at step 502, and begins to monitor the network for a message from the resource (e.g. server) the client needs information about at step 504. The server (or other network resource) broadcasts a message containing information about the server over the network from time to time at step 510. The broadcast may be periodic, or it may be in response to some event occurring on the server. The broadcast could be made at random, or at a random time within a bounded time window. The client determines at step 506 if it has received the message from the resource. If the client has not received the message, the client continues to monitor the network for the message at step 504. When the message is received, the client may use the information in the message to connect to the network resource at step 508.

### Exemplary Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

FIG. 8 provides a schematic diagram of an exemplary networked or distributed computing environment. The distributed computing environment comprises computing objects 810, 812, etc., and computing objects or devices 820, 822, 824, 826, 828, etc., which may include programs, methods, data stores, programmable logic, etc. as represented by example applications 830, 832, 834, 836, 838. It can be appreciated that computing objects 810, 812, etc. and computing objects or devices 820, 822, 824, 826, 828, etc. may comprise different devices, such as personal digital assistants (PDAs), audio/video devices, mobile phones, MP3 players, personal computers, laptops, etc.

Each computing object 810, 812, etc. and computing objects or devices 820, 822, 824, 826, 828, etc. can communicate with one or more other computing objects 810, 812, etc. and computing objects or devices 820, 822, 824, 826, 828, etc. by way of the communications network 840, either directly or indirectly. Even though illustrated as a single element in FIG. 8, communications network 840 may comprise other computing objects and computing devices that provide services to the system of FIG. 8, and/or may represent multiple interconnected networks, which are not shown. Each computing object 810, 812, etc. or computing object or device 820, 822, 824, 826, 828, etc. can also contain an application, such as applications 830, 832, 834, 836, 838, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 8, as a non-limiting example, computing objects or devices 820, 822, 824, 826, 828, etc. can be thought of as clients and computing objects 810, 812, etc. can be thought of as servers where computing objects 810, 812, etc., acting as servers provide data services, such as receiving data from client computing objects or devices 820, 822, 824, 826, 828, etc., storing of data, processing of data, transmitting data to client computing objects or devices 820, 822, 824, 826, 828, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 840 or bus is the Internet, for example, the computing objects 810, 812, etc. can be Web servers with which other computing objects or devices 820, 822, 824, 826, 828, etc. communicate via any of a number of known protocols, such as the hypertext transfer protocol (HTTP). Computing objects 810, 812, etc. acting as servers may also serve as clients, e.g., computing objects or devices 820, 822, 824, 826, 828, etc., as may be characteristic of a distributed computing environment.

### Exemplary Computing Device

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 9 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 9 thus illustrates an example of a suitable computing system environment 900 in which one or aspects of the embodiments described herein can be implemented, although as made clear above, the computing system environment 900 is only one example of a suitable computing environment and is not intended to suggest any limitation as to scope of use or functionality. In addition, the computing system environment 900 is not intended to be interpreted as having any dependency relating to any one or combination of components illustrated in the exemplary computing system environment 900.

With reference to FIG. 9, an exemplary remote device for implementing one or more embodiments includes a general purpose computing device in the form of a computer 910. Components of computer 910 may include, but are not limited to, a processing unit 920, a system memory 930, and a system bus 922 that couples various system components including the system memory to the processing unit 920.

Computer 910 typically includes a variety of computer readable media and can be any available media that can be accessed by computer 910. The system memory 930 may include computer storage media in the form of volatile and/or nonvolatile memory such as read only memory (ROM) and/or random access memory (RAM). By way of example, and not limitation, system memory 930 may also include an operating system, application programs, other program modules, and program data.

A user can enter commands and information into the computer 910 through input devices 940. A monitor or other type of display device is also connected to the system bus 922 via an interface, such as output interface 950. In addition to a monitor, computers can also include other peripheral output devices such as speakers and a printer, which may be connected through output interface 950.

The computer 910 may operate in a networked or distributed environment using logical connections to one or more other remote computers, such as remote computer 970. The remote computer 970 may be a personal computer, a server, a router, a network PC, a peer device or other common network node, or any other remote media consumption or transmission device, and may include any or all of the elements described above relative to the computer 910. The logical connections depicted in FIG. 9 include a network 972, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising:
receiving, at a client computing device that is communicatively connected to a network, a request to establish communication with a server computing device on the network, the request received in response to a failed domain name system (DNS) resolution attempt;
running a tool on the client device in response to the request, the tool causing receipt of a message at the client computing device from the server computing device, the message containing information which the client computing device can use to communicate with the server computing device via unicast communication.

2. The method of claim 1, wherein running the tool comprises broadcasting a broadcast message from the client computing device.

3. The method of claim 2, wherein broadcasting the broadcast message comprises broadcasting a user datagram protocol (UDP) request over the network.

4. The method of claim 3, wherein receiving the message includes receiving an internet protocol (IP) address of the server computing device that is associated with a name of the server computing device.

5. The method of claim 4, further comprising, storing the name of the server computing device and the IP address of the server computing device on the client computing device, and using the IP address of the server and the name of the server to access the server

6. The method of claim 1 further comprising, running the tool as part of a bare metal restore of the client computing device or the server computing device.

7. The method of claim 6 further comprising broadcasting, from the server computing device, the name of the server and the IP address of the server, over the network.

8. The method of claim 1 further comprising broadcasting, from the server computing device, the name of the server and the IP address of the server, over the network.

9. The method of claim 8 wherein broadcasting from the server computing device occurs as part of a of a bare metal restore of the server computing device

10. The method of claim 1 further comprising, occasionally broadcasting over the network, from the server computing device, the message containing information by which the client computing device can communicate with the server computing device via unicast communication.

11. In a computing environment, a system comprising, a server computing device that is communicatively connected to a computer network, the server computing device configured to receive a broadcast message requesting information about the server computing device over a computer network to which the server computing device is connected, and further configured to send, in response to receiving the broadcast message, a response over the computer network, the response containing server identification-related information by which a client computing device can establish unicast communication with the server computing device.

12. The system of claim 11, wherein the server computing device is further configured to include a name of the server computing device and an internet protocol (IP) address of the server computing device in the response.

13. The system of claim 11, further comprising a client computing device configured to send the broadcast message over the computer network.

14. The system of claim 13, wherein the server computing device is further configured to include a name of the server computing device and an internet protocol (IP) address of the server computing device in the response, and wherein the client computing device is further configured to receive the response from the server computing device.

15. The system of claim 14, wherein the client computing device is further configured to use the name of the server computing device and IP address of the server computing device to establish unicast communication with the server computing device.

16. The system of claim 14, wherein the client computing device is further configured to save the name of the server computing device and IP address of the server computing device.

17. The system of claim 16, wherein the client computing device saves the name of the server computing device and IP address of the server in a local cache for access by one or more components of the client computing device.

18. In a computing environment, a system comprising, a client computing device communicatively connected to a computer network, the client computing device configured to:
attempt to connect to a server computing device over the computer network using a domain name system (DNS) proxy; and
employ a tool to facilitate a connection to the server computing device, the tool configured to send a broadcast message over the computer network, to the server computing device, the broadcast message requesting a name and internet protocol (IP) address of the server computing device, the tool further configured to receive a response including the name of the server computing device and the IP address of the server computing device, and to store the name of the server computing device and the IP address of the server computing device on the client computing device.

19. The system of claim 18, wherein the tool is further configured to await a response from the server computing device for a first period of time before resending the broadcast message, and to resend the message up to a number of times after waiting the first period of time.

20. The system of claim 19, wherein the tool is further configured to, after resending the message the number of times, delay for a second period of time or until an event is detected, and retry resending one or more broadcast messages.
